(19) United States
(12) Patent Application Publication
(10) Pub. No.: US 2013/0275171 A1
(43) Pub. Date: Oct. 17, 2013

(54) Systems and Methods for Getting a Baby to Sleep Using Adaptive Adjustments

(71) Applicant: Strategyn Equity Partners, LLC, San Francisco, CA (US)

(72) Inventors: Anthony W. Ulwick, Mill Valley, CA (US); James M. Haynes, III, San Francisco, CA (US)

(21) Appl. No.: 13/830,994

(22) Filed: Mar. 14, 2013

Related U.S. Application Data
(60) Provisional application No. 61/610,670, filed on Mar. 14, 2012.

(51) Int. Cl. G06Q 10/10

(52) U.S. Cl. CPC G06Q 10/1093
USPC 705/7.18

(57) ABSTRACT

A system includes a first interface engine and a routine determining engine. The first interface engine interfaces with a scheduling program and retrieves from the scheduling program. The routine determining engine determines a routine from a from the schedules of the users and schedule for the user to execute the routine to get a baby or child to sleep through the night. The routine determining engine determines the routine and the schedule based on the schedules of the user and optimal routine to get a baby or child to sleep through the night.

### CROSS-REFERENCE TO RELATED APPLICATIONS

The present application claims the benefit of priority to U.S. Provisional Patent Application Ser. No. 61/610,670, filed on Mar. 14, 2012 and entitled “System and Method for Getting a Baby to Sleep through the Night,” which is incorporated by reference herein.

### TECHNICAL FIELD

The technical field relates to information and computer systems. More particularly, the technical field relates to digital scheduling systems and methods.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Dependent people, such as babies, small children, handicapped individuals, and the elderly, may require care from caregivers. For instance, parents may have to care for their babies. One aspect of care that requires management is sleep. Dependent people typically have a sleep cycle, which is sometimes periodic and sometimes not. It is often difficult for caregivers to get dependent people to sleep. Typically, caregivers are unable to identify the information that a dependent person's sleep cycle requires. Caregivers are also often unable to evaluate the materials that are required to coax the dependent person to get to sleep. Further, a dependent person's routines may be erratic and may not provide enough data for caregivers to make reasoned decisions about their routines. Caregivers also have to manage their own schedules, the schedules of other caregivers, and the schedules of dependent people. Caregivers, however, cannot be sure that they will get their dependents to sleep for a period of time successfully. These and other deficiencies reside in the art.

### SUMMARY

A system includes a first interface engine and a routine and schedule determining engine. The first interface engine interfaces with a routine scheduling program and retrieves calendaring and scheduling information. The routine engine can determine either or both a schedule and an optimal routine to get a baby or child to sleep for a period of time. The routine engine can determine the schedule based on information about the parents and caregivers schedule, the execution of the routine, the age of the baby, the activities of the baby, and the amount of food consumed at each feeding by the baby.

A method includes can include interfacing with a routine scheduling program and retrieving from the routine scheduling program timing, feeding, and activity information for a parent or caregiver. The method can further include determining both the optimal routine and a schedule that coordinates with the schedules of the parents and the caregivers. The determinations can be based on information about parents and caregivers schedule, the sleep patterns of the baby or child and the feedings of baby or child and the activities of the baby or child.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

FIG. 1A depicts an example of a system 100 configured to determine an optimal routing and schedule for getting a baby or child to sleep for a period of time.

FIG. 1B is a functional block diagram 100 of the communication system of FIG. 1A.

FIG. 2 is a flowchart of a method 200 for ensuring that a parent can successfully get a baby or child to sleep through the night; and

FIG. 3 is an example of an implementation 300 of the system and method shown in FIGS. 1B and 2.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical “or”. It should be understood that steps within a method may be executed in different order without altering the principles of the present disclosure.

As used herein, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. The term engine may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term engine may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple engines may be executed using a single (shared) processor. In addition, some or all code from multiple engines may be stored by a single (shared) memory. The term group, as used above, means that some or all code from a single engine may be executed using a group of processors or a group of execution engines. For example, multiple cores and/or multiple threads of a processor may be considered to be execution engines. In various implementations, execution engines may be grouped across a processor, across multiple processors, and across processors in multiple locations, such as multiple servers in a parallel processing arrangement.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure relates to systems and methods for ensuring that parents can successfully get a baby to sleep through the night. The systems and methods are implemented using the computer-readable medium. The systems and methods can automatically gather scheduling information. Based on the schedules of the parents and caregivers, the systems and methods can automatically determine the optimal routine for getting a baby to sleep through the night. For example, when parents and caregivers define the routine for the baby, the systems and methods perform the following functions automatically (i.e., without intervention or interaction from the parents or caregivers) based on the schedules of the parents or caregivers and the information about the optimal routine for the baby or child.

The systems and methods determine the nighttime sleep schedule that best accommodates the parents or caregivers work schedules by automatically retrieving scheduling information, the age of the baby or child, the routine. The predicted routine and schedule can be generated based on baby and child development information available in respective databases. The schedule and routine are automatically output to one or more devices of the user (e.g., a phone, a tablet, a laptop, or a personal computer (PC)). Further, prior to carrying out the routine each day, the systems and methods continue to monitor information about the baby or child's sleep and feeding patterns and update the schedules and routines based on changes in the information about the baby or child's sleep patterns.

When the parents or caregivers carry out the routine, the systems and methods continue to monitor the scheduling, feeding and activity information and update the scheduling routine based on changes in the information. The systems and methods may interface with an output system (e.g., a phone, a tablet, a laptop, or a personal computer (PC)) and inform the parents or caregiver of the changes to the schedule or routine via the output system. During the execution of the routine, the systems and methods may also interface with third party database systems and use the system to improve the routine and schedule. Further, the systems and methods may interface with a third party scheduling system an alter the routine or schedule based on data received from the third party scheduling system, and update the routine scheduling program.

Additionally, before the parents or caregivers carry out the routine, the systems and methods may learn historical patterns of babies and children sleeping through the night. For example, depending on the sleep habits of the baby or child, the parent or caregiver may optimize the routine's schedule in a different manner. Depending on the historical pattern of the baby or child's sleep, the systems and methods may automatically optimize the routine and schedule and adjust plan to carry out the routine accordingly so that the parent or caregiver can get the baby or child to sleep through the night successfully.

Further, the systems and methods may gather information about the feedings of the baby or child and select a new routine and schedule based on the needs of the parent or caregiver, and adjust the routine. During the execution of the routine, the systems and methods may continue to gather information about baby or child, update the routine based on constraints of the parents or caregivers and the availability of schedules, and guide the person to the best available routine.

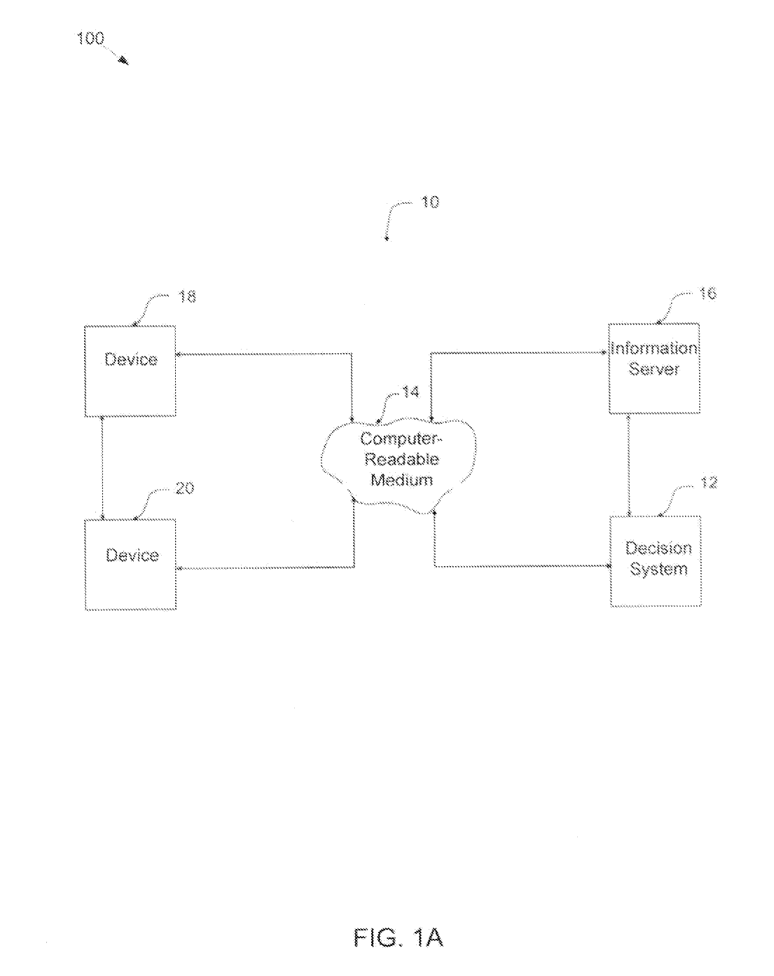

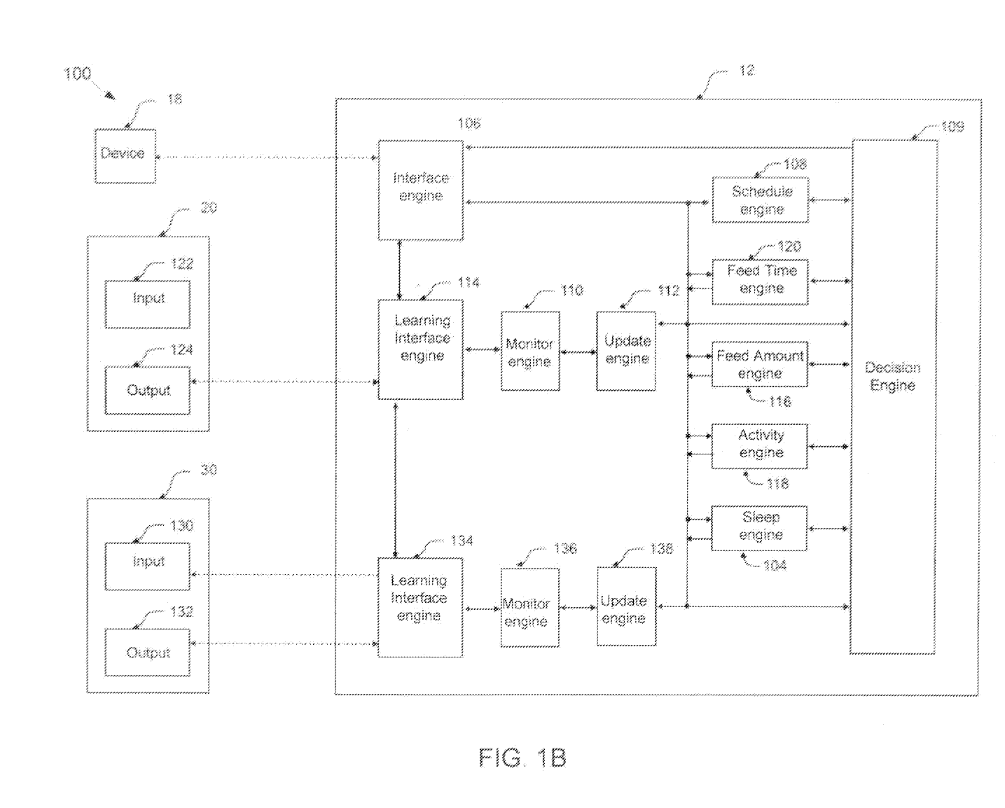

FIG. 1A depicts an example of a system that can be configured to determine an optimal routing and schedule for getting a baby or child to sleep for a period of time. The systems and methods of the present disclosure may be implemented using a computer-readable medium 14.

In the example of FIG. 1, the computer-readable medium 14 can include communications hardware within a single computer, a device locally attached to a computer, or a networked system that includes several computer systems coupled together, such as a local area network (LAN), campus area network (CAN), municipal area network (MAN), or wide area network (WAN), but could include any applicable type of network, such as a personal area network (PAN).

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Networks can include enterprise private networks and virtual private networks (collectively, private networks). As the name suggests, private networks are under the control of an entity rather than being open to the public. Where context dictates a single entity would control a network, it should be understood that reference to a network is a reference to the private portion subset of that network. For example, a LAN can be on a WAN, but only the LAN under the control of an entity; so if an engine controls policy on the network, it may be that the engine only controls policy on the LAN (or some other subset of the WAN). Private networks include a head office and optional regional offices (collectively, offices). Many offices enable remote users to connect to the private network offices via some other network, such as the Internet.

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art.

For illustrative purposes, it is assumed the computer-readable medium 14 broadly includes, as understood from relevant context, anything from a minimalist coupling of the components, or a subset of the components, illustrated in the example of FIG. 1, to every component of the Internet and networks coupled to the Internet. In the example of FIG. 1, the computer-readable medium 14 can include a data path, such as a bus, in a computer. In such an implementation, one or more of the components illustrated in the example of FIG. 1 can be implemented on the same machine.

In some embodiments, a system 10 may include a decision system 12 for ensuring that a parent or caregiver carries out the routine successfully according to the present disclosure. The system 10 may further include the computer-readable medium 14, an information server 16, a device 18, and a device 20. The device 18 and the device 20 can communicate with the computer-readable medium 14 using one or more networks. For example, the networks may include a cellular network, a satellite network, a local area network (LAN), and/or a wide area network (WAN).

The device 18 or device 20 can execute an optimization program, which a person can use to determine an optimal routine. A routine can be optimal if it increases the chances that a baby or child will sleep for a period of time with respect to the chances of the baby or child sleeping for a period of time without the use of the routine. The optimization program (e.g., a scheduling and routine program) may run on the information server 16 and/or on decision system 12. The device 18 may connect to the information server 16 and/or decision system 12 via the computer-readable medium 14. While only two devices, one information server, and one decision system are shown, the system 10 may include multiple devices and information servers. Further, the information server 10 and the decision system 12 may be distributed at multiple geographic locations.

The decision system 12 communicates with the device 18, the device 20, and the information server 16 via the computer-readable medium 14. Communications between the decision system 12 and each of the device 18, the information server 16, and the device 20 can be secured based on subscription of the parent or caregiver to the decision system 12. The decision system 12 may maintain and/or access multiple databases via the computer-readable medium 14. The databases may include information relating to schedules or the parents, the schedules of the caregivers, third party schedules, the feeding times of the baby or child, the feeding amounts of the baby or child, the activities of the baby or child, the sleep times of the baby or child, the nap times of the baby or child, etc.

In use, the person can use the device 18 to determine a routine. The user can determine the routine at any location, such as home, office, etc. The routine information (e.g., scheduling information, etc.) is stored on the information server 16. The decision system 12 can retrieve the scheduling information from the information server 16 via the computer-readable medium 14 or another network, such as a LAN. The decision system 12 sets up schedule for the parent or caregiver based on the scheduling information. The decision system 12 gathers and monitors schedule, feeding, sleeping, napping, and other information on an ongoing basis. The decision system 12 updates the schedule, feeding, sleeping, napping, and other information based on changes in the information that will impact carrying out the routine for the baby or child. The decision system 12 sends the schedule, feeding, sleeping, napping, and other information and updates to the device 18. The decision system 12 may also set up one or more routines based on the historical patterns of parents getting their baby or child to sleep through the night.

When the person begins the routine, the decision system 12 communicates with the device 20 in addition to, or instead of, the device 18. If multiple persons use the device 18 or device 20, the communication system 12 may identify the person based on the identification information of the person stored in the device 18 or device 20. The device 18 may communicate with the device 20 via Bluetooth®, for example. Alternatively or additionally, the person may use log in information to operate the device 18 or device 20. The decision system 12 may retrieve the identification information of the person from the device 18 and/or the device 20. Based on the identification information, the decision system 12 may monitor and update the schedule of the identified parent or caregiver. The decision system 12 may output updated information to the parent or caregiver via an output system (e.g., a phone, tablet, web browser, or personal computer (PC)) of the device 18 or device 20. The decision system 12 may also adjust the schedule and routine depending on the schedule and whether the person can get the baby or child to sleep successfully.

Referring now to FIG. 1B, the decision system 12 is shown in detail. The computer-readable medium 14 and the information server 16 are omitted for simplicity of illustration. The learning engine 20 may include one or more information input systems 122 and/or one or more information output systems 124. The information input systems 122 may include a schedule, a routine, a feeding amount, a sleep schedule, etc. For example, the information input systems 122 may include feeding amount information. The output systems 124 may include information to improve the decision making of decision engine 109.

The decision system 12 includes a device interface engine 106, a schedule engine 108, a decision engine 109, a monitoring engine 110, an updating engine 112, a learning information interface 114, a feed amount engine 116, an activity engine 118, a feed time engine 120, and a sleep pattern engine 104. The device interface engine 106 interfaces the communication system 12 to the device 18, the device 20, or the device 30 via the computer-readable medium 14. The learning interface engine 114 can interface with the decision system 12 to one or more information input systems 122 and/or one or more information output systems 124 of the learning engine 20 via the computer-readable medium 14 or via another network, for example, a local area network.

The schedule engine 108 interfaces with the routine schedule program via the device interface engine 106. Alternatively, the schedule engine 108 may interface with the routine schedule program via the computer-readable medium 14. The schedule engine 108 retrieves information from the routine schedule program. The feed time engine 120 interfaces with the routine schedule program via the device interface engine 106. Alternatively, the feed time engine 120 may interface with the routine schedule program via the computer-readable medium 14. The feed time engine 120 retrieves information from the routine schedule program. The feed amount engine 116 interfaces with the routine schedule program via the device interface engine 106. Alternatively, the feed amount engine 116 may interface with the routine schedule program via the computer-readable medium 14. The feed amount engine 116 retrieves information from the routine schedule program. The activity engine 118 interfaces with the routine schedule program via the device interface engine 106. Alternatively, the activity engine 118 may interface with the routine schedule program via the computer-readable medium 14. The activity engine 118 retrieves information from the routine schedule program. The sleep engine 104 interfaces with the routine schedule program via the device interface engine 106. Alternatively, the sleep engine 104 may interface with the routine schedule program via the computer-readable medium 14. The sleep engine 104 retrieves information from the routine schedule program.

The decision engine 109 determines the nighttime sleep schedule, the optimal routine, the optimal plan to carry out the routine for the parents and the caregivers, and the schedules for the parents and the caregivers. For example, the decision engine 109 determines when the routine needs to be altered to get a baby to sleep through the night.

The decision engine 109 determines sleep schedule and the routine based on the schedules of the parents and caregivers, the feed amounts, the feed times, the nap times, the activities of the baby or child, etc. The decision 109 outputs the routine and schedule to the user on the device 18. The device engine 109 receives information from the monitoring engine 110. The monitoring engine 110 monitors the past and current information patterns and determines when the information patterns change in a way that would impact getting the baby to sleep through the night.

Specifically, prior to carrying out the routine the monitoring engine 110 monitors the schedules, the feedings, and the activities required to get a baby or child to sleep through the night. The updating engine 112 may update the schedule based on the monitored routine, feedings, sleep patterns and activities. The decision engine 109 outputs the updated schedule and routine to the user on the device 18.

The monitoring engine 110 may monitor the schedule, feeding, activity, and sleep information using various sources. For example, the monitoring engine 110 may access databases on the computer-readable medium 14. The monitoring engine 110 may access the databases directly via the computer-readable medium 14 or via the device 18, which may have a connection to the computer-readable medium 14.

Additionally, prior to carrying out the routine, the decision engine 109 may determine/update the sleep schedule and/or the feeding schedule based on inputs received from the schedule engine 108, feed time engine 120, feed amount engine 116, and/or activity engine 118. For example, the decision engine 109 may determine the optimal schedule based on the feed amount patterns learned by the learning engine 20.

The learning engine 20 may learn the routine patterns from schedule data gathered during prior executions of the routine. For example, the learning engine 20 may gather the schedule data from feed time engine 120 or activity engine 118. Alternatively or additionally, the learning engine 20 may gather the routine data from one or more databases maintained on the computer-readable medium 14. The databases may include the JOB data gathered from prior routines, communications made by the parents or caregivers using the device 18, etc. The learning engine 20 may access the databases directly via the computer-readable medium 14 or via the device 18, which may have a connection to the computer-readable medium 14.

The activity engine 118 may determine the activity schedule using the activity patterns. The activity engine 118 may optimize the routine based on the sleep patterns. The decision engine 109 may adjust the routine and the schedule based on the activity routines.

The feed time engine 120 may receive feed schedule and may select the optimal schedule to get the baby or child to sleep through the night. The feed time engine 120 may select the feed time based on factors such as the amount of food consumed by the baby or child at each feeding. The decision engine 109 may determine/adjust the feed time schedule.

When the parents or caregivers execute the routine, the monitoring engine 110 monitors the information while the user carry's out the routine. The monitoring engine 100 may monitor the routine by accessing relevant databases on the computer-readable medium 14. The monitoring engine may access the databases directly via the computer-readable medium 14, via the device 18, or via one or more of the engines 122, which may have connections to the computer-readable medium 14. Additionally, the monitoring engine 110 may infer the schedules from data received from a control system that monitors the schedules etc., for example.

The updating engine 112 may update the routine schedules based on the monitored feeding, sleep, and activity information and other information. The decision engine 109 may output the updated routine schedules to the parents or caregivers via one or more of the output systems 124 of the device 20. For example, the decision engine 109 may output the updated routing on a display of device 20.

Though the foregoing description discusses the learning engine 20 (which includes the information input systems 122 and/or the information output systems 124), it is noted that various embodiments may include a learning engine 30, which includes an information input system 130 and an information output system 132. The learning engine 30 may be configured to interface with a learning interface engine 134. The learning interface engine 134 may be coupled to a monitor engine 136, which in turn is shown coupled to an update engine 138. The learning engine 30 may be configured similarly to the learning engine 20.

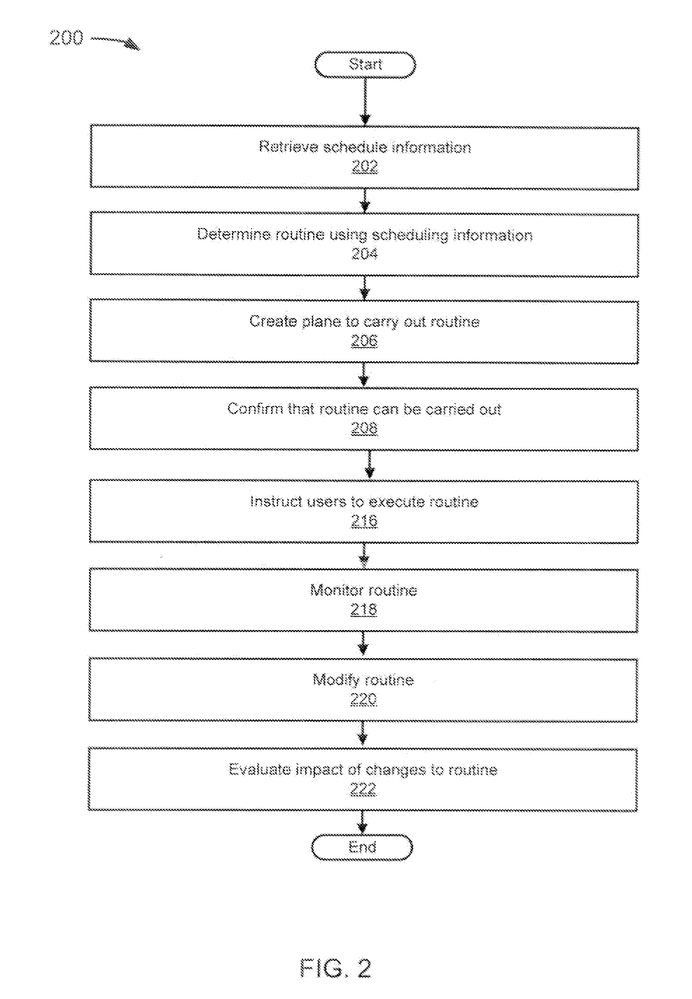

Referring now to FIG. 2, a job map (method) 200 for ensuring that a parent or caregiver can get a baby or child to sleep through the night is shown. Unlike a process map that shows operations performed by parent or caregiver, the job map 200 shows functions performed by the systems and methods of the present disclosure. These functions help the parent or caregiver perform the operations. The context in which parents or caregivers execute the job may include but are not limited to home, office, or school. The job map 200 outlines a solution that uses information to help a parent or caregiver get a baby or child to sleep through the night.

Control begins at 202 and retrieves schedule information from the calendar program of the user and estimates the optimal nighttime sleep schedule. Control determines the routine that will get the baby or child to sleep through the night at 204. For example, determining the routine may include determining how long the baby or child should stay awake during the day. Control organizes the plan to carry out the routine at 206. For example, the plan may include which parent or caregiver is available to carry out the routine each day. At 208, control confirms that the routine can be carried out. At 216, informs the parents or caregivers to execute the routine at the appropriate times.

At 218, control monitors all the elements of the routine. At 220, control makes modifications to the routine.

At 222, control evaluates the impact of the changes in the routine on the sleep schedule and informs the routine schedule and the parents and caregivers

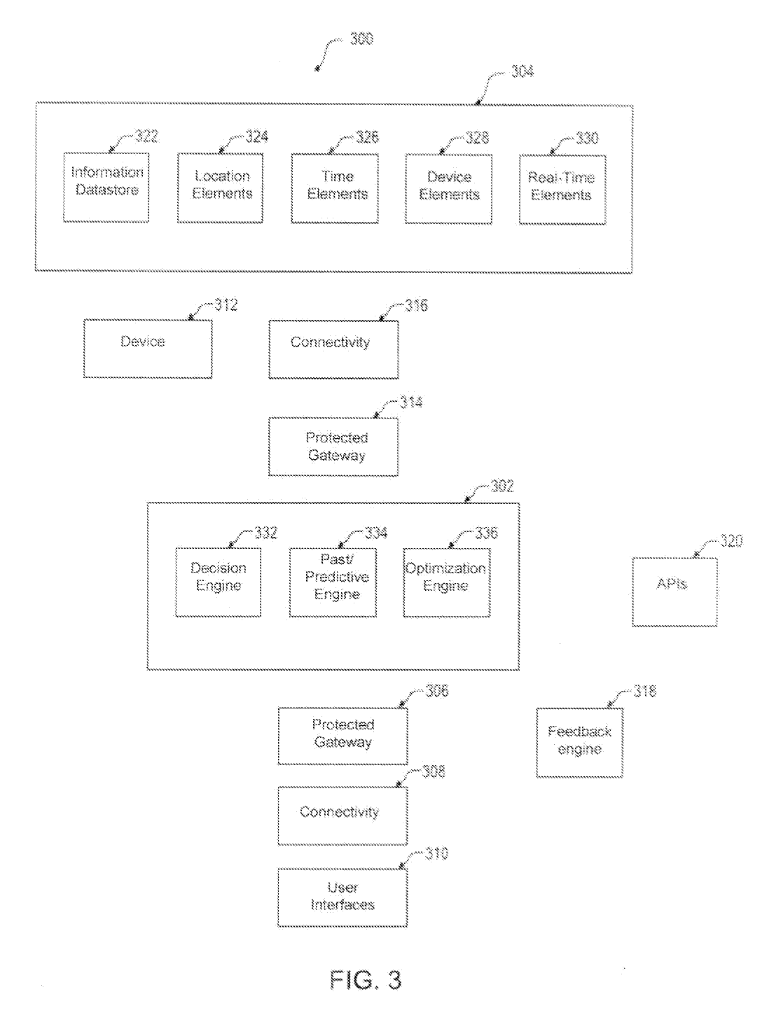

Referring now to FIG. 3, an example of an implementation 300 of the communication system 12 and the method 200 is shown. The implementation 300 utilizes a decision-making engine (shown as engines) 302 that processes information from different sources (e.g., information engine 304) and that helps ensure that a parent or caregiver can get a baby or child to sleep through the night with minimal effort. The decision-making engine 302 works with existing devices of a customer (shown as user interfaces 310, e.g., PC, laptop, phone, or tablet) and calendar services (e.g. Outlook, iCal, Google Calendar). The decision-making engine 302 can access the devices via a protected gateway 306, which connects to the user interfaces 310 via one or more networks (shown as connectivity) 308.

The decision-making engine 302 can also be integrated with other systems (shown as device) 312. The decision-making engine 302 can retrieve information about the routine. For example, the decision-making engine 302 can communicate with the device 312 via a protected gateway 314, which connects to the device 312 via one or more networks (shown as connectivity) 316.

The decision-making engine 302 can access the information in the information engine 304 through the protected gateway 314 and connectivity 316. Alternatively or additionally, the decision-making engine 302 can access the information in the information engine 304 through the protected gateway 306, connectivity 308, user interfaces 310, and a feedback engine 318. The feedback engine 318 allows the decision-making engine 302, the user interfaces 310, and the information engine 304 to exchange data. Additionally, the feedback engine 318 allows the decision-making engine 302 to learn preferences of the person (e.g., infer preferred schedules). The decision-making engine 302 can also include application programming interfaces (APIs) 320. The APIs 320 allow the decision-making engine 302 to pull data from multiple sources having information related to feeding, sleeping, activities, etc.

More specifically, the information engine 304 includes information datastores 322 such as calendar programs of users and other calendars. As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself Many data structures use both principles, sometimes combined in non-trivial ways. The implementation of a data structure usually entails writing a set of procedures that create and manipulate instances of that structure.

The information engine 304 also includes location elements 324, time elements 326, device elements 328, and real-time elements 330. The location elements 324 identify where the user is located at any given time. The time elements 326 characterize time of the day. The device elements 328 provide information about configurations and capabilities of devices. The real-time elements 330 provide real-time information (e.g., when the routine should start and stop).

The decision-making engine 302 performs core decision-making functions using various decision-making engines. For example, the decision-making engine 302 may include a decision engine 332 to decide the routine and schedules based on the information received from the information engine 304. A past/predictive engine 334 analyzes past (historical) data related to the feeding, activities, sleep patterns, etc. The past/predictive engine 334 provides related predictive data to the decision engine 332 and an optimization engine 336. The optimization engine 336 optimizes the decisions related to the routine and the schedules based on the predictive data.

The decision-making engine 302 may include additional engines. One or more of these engines may be included in, or may be part of, other engine or engines in the decision-making engine 302. One or more of these engines may exchange information with other engines in the decision-making engine 302.

The decision-making engine 302 makes decisions based on the information received from the information engine 304 and in turn also update the information in the information engine 304 with the decisions made. For example, the decision-making engine 302 may update the information in the information engine 304 via the feedback engine 318. The decision-making engine 302 can perform the core decision-making functions in the computer-readable medium cloud, which allows ongoing and automatic updates to the decisions and the information in the information engine 304 with minimal effort or activity required from the customer.

The decision-making engine 302 works with most popular devices and does not require additional end-user hardware. The decision-making engine 302 can detect resources available to the user (e.g., device or devices used by the user, data plans used by the user, etc.) and scale service depending on available resources. Minimally essential capability is made available on a user-owned device.

Functions or services performed by the decision-making engine 302 can be scaled up as more resources become available. Further, the services can be scaled on a subscription basis. The services are scalable to multiple users. The services can be provided in different geographic areas. The services can utilize existing data plans of the customer for transferring data to the phone device of the user (e.g., providing alerts including updated routine times by SMS). The services interface with other devices of the user either directly or as a tether/conduit to the device instead. The decision-making engine 302 can also cache data in case of lapses in cellular coverage. If connectivity is lost, the decision-making engine 302 will provide service with at least the information as of when the connectivity was lost.

Further, the decision-making engine 302 minimizes privacy barriers to adoption and use of the services. Individual identification information is not retained at any central server sites longer than necessary. Individual historical data are retained only on user-controlled devices.

In summary, when a user enters information in the system, the communication system 12 automatically synchronizes with a user's calendar, identifies the optimal schedule, calculates the optimal routine, determines optimal schedules for the parents, caregivers, and baby or child, and creates a scheduled routine on the user's calendar. If the needs of the baby or child change, the communication system 12 automatically adjusts the time on the user's calendar and notifies the user of a new routine. This feature also allows the communication system 12 to track the person's schedule and time allocated to execute the routine.

The communication system 12 includes a device synchronization feature. This allows the parent or caregiver to automatically connect to the system so that routine and schedule updates can be provided by the communication system 12. Device synchronization provides at least the following benefits to the person while getting a baby or child to sleep through the night.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A system comprising:
a first interface engine that interfaces with a scheduling program and that retrieves from the scheduling program available times for the user; and
a routine determining engine that determines the optimal routine for getting a baby or child to sleep through the night,
wherein the routine determining engine determines the routine and schedule based on the schedules of the parents and caregivers and the routine and schedule of the baby or child.

2. The system of claim 1 further comprising:
a monitoring engine that monitors schedules, feeding times, feeding amounts, activities, sleep patterns, and sleep schedules; and
an updating engine that updates the routine based on the schedules of the parents, the caregivers and the baby or child.

3. The system of claim 1 further comprising:
a monitoring engine that monitors the sleep patterns of the baby or child while the parent or caregiver executes the routine; and
an updating engine that updates the routine based on the monitored information.

4. The system of claim 1 further comprising a routine optimization engine that optimized the routine for the user between executions of the routine, wherein the routine optimization engine determines the routine and the schedules based on the information.

5. The system of claim 4 further comprising a learning engine that learns sleep patterns of the baby or child and the schedules of the parents or caregivers, wherein the routine engine plans the routine for the user.

6. The system of claim 1 wherein:
the scheduling program is executed by at least one of a plurality of devices including a smartphone, a tablet, a laptop computer, and a personal computer; and
the first interface engine receives at least one of the routine and the schedule time from the routine determining engine and outputs the routine and the schedule to the user on the at least one of the plurality of devices.

7. The system of claim 3 further comprising a second interface engine that interfaces with an output system of a device of the user and that outputs the updated routine to the user on the output system.

8. The system of claim 3 further comprising a second interface engine that interfaces with a control system of a device of the user, wherein the monitoring engine monitors the routine using the control system.

9. The system of claim 3 further comprising a second interface engine that interfaces with a control system of a device of the user and that receives data related to routine, wherein the updating engine updates the routine based on the data.

10. A method comprising:
interfacing with a scheduling program and retrieving from the scheduling program a routine for getting a baby or child to sleep through the night using the scheduling program; and
determining the optimal routine to get a baby or child to sleep through the night,
wherein the determinations are based on the schedules of the parents or caregivers and the information about the sleep, feed, and activity patterns of the baby or child.

11. The method of claim 10 further comprising:
monitoring the routine prior to the next execution of the routine; and
updating the routine based on the monitored information.

12. The method of claim 10 further comprising:
monitoring engine while the user executes the routine; and
updating the routine based on the monitored information.

13. The method of claim 10 further comprising:
planning one or more routine activities for the user between the executions of the routine; and
determining the routine and the schedule.

14. The method of claim 13 further comprising:
learning routine patterns of the user; and
planning the routine for the user based on the routine patterns.

15. The method of claim 10 wherein:
executing the scheduling program on at least one of a plurality of devices including a smartphone, a tablet, a laptop computer, and a personal computer; and
outputting at least one of the route and the departure time to the user on the at least one of the plurality of devices.

16. The method of claim 13 further comprising:
interfacing with an output system of a device of the user; and
outputting the updated routine to the user on the output system.

17. The method of claim 13 further comprising:
interfacing with a control system of a device of the user; and
monitoring the routine using the control system.

18. The method of claim 13 further comprising:
interfacing with a control system of a device of the user;
receiving data related to operation of the device; and
updating the routine based on the data.
